(19) United States
(12) Patent Application Publication
(10) Pub. No.: US 2015/0326469 A1
(43) Pub. Date: Nov. 12, 2015

(54) OAM AIDED EXPLICIT PATH REPORT VIA IGP

(71) Applicant: Telefonaktiebolaget L M Ericsson (publ), Stockholm (SE)

(72) Inventors: Andras Kern, Budapest (HU); Janos Farkas, Kecskemet (HU)

(21) Appl. No.: 14/707,975

(22) Filed: May 8, 2015

Related U.S. Application Data
(60) Provisional application No. 61/991,306, filed on May 9, 2014.

(51) Int. Cl. H04L 12/761; H04L 12/24; H04L 12/46; H04L 12/723; H04L 12/721

(52) U.S. Cl. CPC H04L 45/16; H04L 45/50; H04L 45/12; H04L 12/4641; H04L 41/0866; H04L 41/0806

(57) ABSTRACT

A method is implemented by a network device to establish an explicit path in a network domain including a plurality of network devices including the network device. The explicit path defines a path for forwarding traffic across the network domain that is generated by a path computation element (PCE) in communication with the network domain. Operations, administration and management (OAM) is provided to support checking the establishment and correctness of the explicit path based on interior gateway protocols. The network device receives an explicit path descriptor (EPD) defining an explicit path configuration including configuration attributes for a maintenance endpoint (MEP) or maintenance intermediate point (MIP) where the EPD is generated and distributed by the PCE. The MEP or the MIP is established according to the EPD, the MEP or MIP to monitor the explicit path. A correctness test is performed to check correctness of the explicit path utilizing the MEP or MIP.

### CROSS REFERENCE TO RELATED APPLICATIONS

The present application depends from and claims priority to U.S. Provisional Application No. 61/991,306, filed May 9, 2014, the contents of which are incorporated herein by reference.

### FIELD

Embodiments of the invention relate to the field of interior gateway protocols such as intermediate system to intermediate system (IS-IS) routing protocol or open shortest path first (OSPF). More specifically, the embodiments relate to systems and processes for the establishment of explicit paths within a domain and for the checking of the proper establishment of these explicit paths, where the explicit paths can be multipoint paths also referred to as explicit trees.

### BACKGROUND

Link-state control protocols, such as the Intermediate System to Intermediate System (IS-IS) or the Open Shortest Path First (OSPF), are distributed protocols that are most often used for the control of data packet routing and forwarding within a network domain. Link state protocols are executed by each node and collect information about the adjacent neighbor nodes of the node by exchanging Hello protocol data units (PDUs) with the adjacent neighbor nodes. The nodes then distribute the information on their neighbors by means of flooding Link-state PDUs (LSP) or Link State Advertisements (LSA). Thus, each node maintains a topology database storing the network domain topology based on the received LSPs or LSAs. Each node then determines a path to each of the possible destination nodes in the topology on its own, which is typically the shortest path often referred to as Shortest Path First. Each node then sets its local forwarding entry to the port through which a given destination node is reachable according to the result of the path computation (i.e., the shortest path). This mechanism ensures that there will be a shortest path set up between any pair of nodes in the network domain.

Shortest Path Bridging (SPB) (IEEE 802.1aq, 2012) specifies extensions to IS-IS for the control of bridged Ethernet networks. SPB is a form of add-on to IS-IS (ISIS, 2002) by defining new type/length/values (TLVs) and the relevant operations. That is, the existing IS-IS features have been kept, but some new features were added for control over Ethernet. SPB uses shortest paths for forwarding and is also able to leverage multiple shortest paths.

The IEEE 802.1Qca draft (IEEE 802.1Qca, 2013) defines an explicit path as a sequence of hops, where each hop defines the next node over which a path must be routed, referred to as Explicit Path Descriptor (EPD), for which an example implementation is the Topology sub-TLV of Qca. An explicit path can be utilized in place of a shortest path to define a path between a node pair in the network domain. The explicit path can also be a multipoint-to-multipoint path, i.e. an explicit tree. As used herein, an EP and EPD are generic to all types of paths, including point to point paths and multipoint paths, with an explicit tree referring to multipoint paths. However, one skilled in the art would understand that the terms could have a reversed relationship with the explicit tree referring to both point to point and multipoint paths and EP referring to the point to point paths (the more recent drafts of the above referenced IEEE 802.1Qca 2014 uses this alternate definition). The EPD is disseminated making use of IS-IS, i.e. flooded in an LSA or LSP throughout the network domain. All nodes, upon receiving this advertisement are able to install the necessary forwarding entries thus an end-to-end explicit path is formed. Then, all nodes, as a result of the local configuration, generate a second advertisement that disseminates the result of the path configuration. Then any system connected to the Ethernet network, including a Path Computation Element (PCE), is able determine whether the path has been successfully installed or the configuration has failed.

The IEEE 802.1Q (IEEE 802.1Q, 2011) describes Connectivity Fault Management (CFM) of Ethernet networks that comprises capabilities for detecting, verifying, and isolating connectivity failures in Virtual Bridged Local Area Networks. The standard introduces Maintenance End Points (MEPs) and Maintenance Intermediate Points (MIPs). The MEPs act as active monitoring points that emit Ethernet CFM datagrams either periodically or based on triggers. The MEPs furthermore receive and process Ethernet CFM datagrams. By deploying MEPs at the endpoint of an Ethernet path, those endpoints become aware of the status of the Ethernet path via periodically emitted CFM datagrams. Based on the content of these datagrams, the endpoints become able to check whether or not the Ethernet path is alive and correct. In addition, the endpoints can also discover performance related characteristics, like delay and loss.

### SUMMARY

The embodiments include a method implemented by a network device to establish an explicit path in a network domain including a plurality of network devices including the network device. The explicit path defines a path for forwarding traffic across the network domain that is generated by a path computation element (PCE) in communication with the network domain. Operations, administration and management (OAM) is provided to support checking the establishment and correctness of the explicit path based on interior gateway protocols. An explicit path descriptor (EPD) is received by the network device where the EPD defines an explicit path configuration including configuration attributes for a maintenance endpoint (MEP) or maintenance intermediate point (MIP) where the EPD is generated and distributed by the PCE. The MEP or the MIP is established according to the EPD, where the MEP or MIP monitors the explicit path. An establishment test is performed to check establishment of the explicit path utilizing the MEP or MIP. A correctness test is performed to check correctness of the explicit path utilizing the MEP or MIP. A path state report is generated including data from the establishment test or the correctness test, and the path state report is sent to the PCE.

The embodiments include a network device that is configured to establish an explicit path in a network domain including a plurality of network devices including the network device. The explicit path defines a path for forwarding traffic across the network domain that is generated by a path computation element (PCE) in communication with the network domain. Operations, administration and management (OAM) support is provided for checking the establishment and correctness of the explicit path based on interior gateway protocols. The network element includes a data store to store a topology of the network domain and a network processor communicatively coupled to the data store. The network processor is configured to execute an interior gateway protocol (IGP) module including support for OAM. The IGP module receives an explicit path descriptor (EPD) defining an explicit path configuration generated and distributed by the PCE. The IGP module establishes a maintenance endpoint (MEP) or maintenance intermediate point (MIP) according to the EPD. The IGP module generates a path state report including data from an establishment test or a correctness test, and sends the path state report to the PCE. The network device further includes a line card communicatively coupled to the network processor. The line card implements the MEP or MIP to monitor the explicit path, to perform the establishment test, to check establishment of the explicit path, and to perform a correctness test to check correctness of the explicit path.

In another embodiment, a method is implemented by a network device to establish an explicit path in a network domain including a plurality of network devices including the network device. The explicit path defines a path for forwarding traffic across the network domain that is generated by a path computation element (PCE) in communication with the network domain. Operations, administration and management (OAM) is provided to support checking the establishment and correctness of the explicit path based on interior gateway protocols. An explicit path descriptor (EPD) is received by the network device defining an explicit path configuration generated and distributed by the PCE. A check is made whether the network device is a path endpoint. A maintenance endpoint (MEP) configuration is determined and the MEP is deployed where the network device is the path endpoint. A check is made where the network device is not an endpoint whether path correctness is requested and the network device is listed as a hop, along the explicit path or that all network devices are to have a maintenance intermediate point (MIP) installed. An MIP configuration is determined and the MIP is deployed where the path correctness is requested and the network device is listed as the hop, along the explicit path or that all network devices are to have the MIP installed.

A network device is configured to establish an explicit path in a network domain including a plurality of network devices including the network device. The explicit path defines a path for forwarding traffic across the network domain that is generated by a path computation element (PCE) in communication with the network domain. Operations, administration and management (OAM) support is provided for checking the establishment and correctness of the explicit path based on interior gateway protocols. The network element includes a data store to store a topology of the network domain and a network processor communicatively coupled to the data store, the network processor to execute an interior gateway protocol (IGP) module including support for OAM. The IGP module receives an explicit path descriptor (EPD) defining an explicit path configuration generated and distributed by the PCE, checks whether the network device is a path endpoint, determines a maintenance endpoint (MEP) configuration, and deploys the MEP where the network device is the path endpoint. The IGP module checks where the network device is not an endpoint whether path correctness is requested and the network device is listed as a hop, along the explicit path or that all network devices are to have a maintenance intermediate point (MIP) installed. The IGP module determines the MIP configuration and deploys the MIP where the path correctness is requested and the network device is listed as the hop, along the explicit path or that all network devices are to have the MIP installed.

In another embodiment, a method is implemented by a network device to establish an explicit path in a network domain including a plurality of network devices including the network device. The explicit path defines a path for forwarding traffic across the network domain that is generated by a path computation element (PCE) in communication with the network domain. Operations, administration and management (OAM) is provided to support checking the establishment and correctness of the explicit path based on interior gateway protocols. The method collects Continuity and Connectivity Messages (CCM) from all remote maintenance endpoints, checks whether all CCM have a cleared remote defect indicator (RDI), and validates an installed explicit path by emitting a linktrace message over each virtual local area network (VLAN) associated with the explicit path and collecting the responses to the linktrace message. The method further sets an explicit path established flag in response to determining that all VLAN identifier is correct from the responses to the linktrace message.

A network device is configured to establish an explicit path in a network domain including a plurality of network devices including the network device. The explicit path defines a path for forwarding traffic across the network domain that is generated by a path computation element (PCE) in communication with the network domain. Operations, administration and management (OAM) support is provided for checking the establishment and correctness of the explicit path based on interior gateway protocols. The network element includes a data store to store a topology of the network domain, and a network processor communicatively coupled to the data store. The network processor executes an interior gateway protocol (IGP) module including support for OAM. The IGP module collects Continuity and Connectivity Messages (CCM) from all remote maintenance endpoints, checks whether all CCM have a cleared remote defect indicator (RDI), validates an installed explicit path by emitting a linktrace message over each virtual local area network (VLAN) associated with the explicit path and collecting the responses to the linktrace message, and sets an explicit path established flag in response to determining that all VLAN identifier is correct from the responses to the linktrace message.

In a further embodiment, a method is implemented by a network device to establish an explicit path in a network domain including a plurality of network devices including the network device. The explicit path defines a path for forwarding traffic across the network domain that is generated by a path computation element (PCE) in communication with the network domain. Operations, administration and management (OAM) is provided to support checking the establishment and correctness of the explicit path based on interior gateway protocols. The method includes checking whether path correctness has been requested by the PCE, discovering an explicit path by emitting a linktrace message over each virtual local area network (VLAN) associated with the explicit path and collecting responses to the linktrace messages, checking discovered routes for each VLAN to find whether all hops listed in an explicit path descriptor are found for the explicit path, and encoding results from the discovering in an explicit path correct flag. The method further includes setting an explicit path established flag and including the explicit path correct flag and the explicit path established flag for the explicit path in a path state report.

A network device is configured to establish an explicit path in a network domain including a plurality of network devices including the network device. The explicit path defines a path for forwarding traffic across the network domain that is generated by a path computation element (PCE) in communication with the network domain. Operations, administration and management (OAM) support is provided for checking the establishment and correctness of the explicit path based on interior gateway protocols. The network element includes a data store to store a topology of the network domain, and a network processor communicatively coupled to the data store. The network processor executes an interior gateway protocol (IGP) module including support for OAM, The IGP module checks whether path correctness has been requested by the PCE, discovers an explicit path by emitting a linktrace message over each virtual local area network (VLAN) associated with the explicit path and collects responses to the linktrace messages. The IGP module checks discovered routes for each VLAN to find whether all hops listed in an explicit path descriptor are found for the explicit path, encodes results from the discovering in an explicit path correct flag, sets an explicit path established flag, and includes the explicit path correct flag and the explicit path established flag for the explicit path in a path state report.

In a further embodiment, a method is implemented by a network device to establish an explicit path in a network domain including a plurality of network devices including the network device. The explicit path defines a path for forwarding traffic across the network domain that is generated by a path computation element (PCE) in communication with the network domain. Operations, administration and management (OAM) is provided to support checking the establishment and correctness of the explicit path based on interior gateway protocols. The method includes waiting for a duration of an explicit path setup delay, validating the explicit path by emitting a linktrace message over each virtual local area network (VLAN) associated with the explicit path and collecting responses to the linktrace message, setting an explicit path established flag in response to all VLAN identifiers being established, checking whether discovered routes for each VLAN have found all hops listed in an explicit path descriptor, encoding results in an explicit path correct flag, and including the explicit path established flag and the explicit path correct flag in a path state report.

A network device is configured to establish an explicit path in a network domain including a plurality of network devices including the network device. The explicit path defines a path for forwarding traffic across the network domain that is generated by a path computation element (PCE) in communication with the network domain. Operations, administration and management (OAM) support is provided for checking the establishment and correctness of the explicit path based on interior gateway protocols. The network element includes a data store to store a topology of the network domain, and a network processor communicatively coupled to the data store. The network processor executes an interior gateway protocol (IGP) module including support for OAM. The IGP module waits for a duration of an explicit path setup delay, validates the explicit path by emitting a linktrace message over each virtual local area network (VLAN) associated with the explicit path and collecting responses to the linktrace message, sets an explicit path established flag in response to all VLAN identifiers being established, checks whether discovered routes for each VLAN have found all hops listed in an explicit path descriptor, encodes results in an explicit path correct flag, and includes the explicit path established flag and the explicit path correct flag in a path state report.

### BRIEF DESCRIPTION OF THE DRAWINGS

The invention may best be understood by referring to the following description and accompanying drawings that are used to illustrate embodiments of the invention. In the drawings:

FIG. 1 is an example diagram of one embodiment of an Ethernet network over which an explicit path is provisioned.

FIG. 2 is a flowchart of one embodiment of a set of processes executed in a network domain to establish an explicit path and to test the explicit path.

FIG. 3 is a flowchart of one embodiment of the EPD processing and explicit path connectivity check configuration process.

FIG. 4 is a diagram of a TLV data structure.

FIG. 5 is a diagram of one embodiment of a path-wide CFM attributes sub-TLV.

FIG. 6 is a diagram of one embodiment of a system-wide CFM attributes sub-TLV.

FIG. 7 is a flowchart of one embodiment of the path establishment test process performed by a first endpoint of the explicit path.

FIG. 8 is a flowchart of one embodiment a process for path correctness testing executed by a first endpoint of an explicit path.

FIG. 9 is a flowchart of one embodiment of a process for performing path correctness by a root system.

FIG. 10 is a diagram of one embodiment of a path state data structure.

FIG. 11 is a flowchart of one embodiment of a process for path state processing.

FIG. 12 is a diagram of one embodiment of a network device implementing the explicit path support processes.

FIG. 13A illustrates connectivity between network devices (NDs) within an exemplary network, as well as three exemplary implementations of the NDs, according to some embodiments of the invention.

FIG. 13B illustrates an exemplary way to implement the special-purpose network device according to some embodiments of the invention.

FIG. 13C illustrates various exemplary ways in which virtual network elements (VNEs) may be coupled according to some embodiments of the invention.

### DESCRIPTION OF EMBODIMENTS

The following description describes methods and apparatus for establishment and checking of explicit paths in a network domain. In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. In particular, blocks illustrated with dashed borders and the related text (whether or not bracketed) relate to operations that may be optional in certain embodiments. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

The operations in the flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

Where Connectivity Fault Management (CFM) is implemented, the endpoint systems of an Ethernet path become aware of the status of that Ethernet path, but any remote system, like a Path Computation Element (PCE) unless it coincides with any endpoint of a path, needs to obtain this status information from the endpoint systems. One possible option makes use of Simple Network Management Protocol (SNMP). Then the PCE either configures the endpoint system via SNMP to send notification or directly reads paths status attributes from the endpoint system. In order to use CFM to check the status of an Ethernet path, the Maintenance End Point (MEP) functions of the endpoint system must be configured. There are several options to do so including management plane configuration protocols, such as SNMP and NetConf, as well as, control plane protocols, such as generalized multi-protocol label switching (GMPLS) signaling.

However, these implementations present problems that the embodiments described herein overcome. Network Management System (NMS) based configuration and monitoring protocols (e.g., SNMP) allows a remote system to configure Ethernet systems to monitor the status of an Ethernet path and to obtain information about the status of the path via either notification or polling attributes stored in the Ethernet systems. However, the NMS based configuration of Operations, Administration and Management (OAM) is troublesome. The use of NMS to configure OAM requires interworking between the NMS and the PCE controlling explicit paths and trees. The NMS needs to connect to each end point individually in order to set up the MEPs for the monitoring of the availability of the paths. If additional monitoring features are to be used, e.g. link trace, then Maintenance Intermediate Points (MIPs) have to be also configured along the path. This is a significant configuration burden creating several issues.

The PCE must configure at least two Ethernet systems in parallel to the creation of a point-to-point Ethernet path using a dedicated protocol. This requires tight integration between the Ethernet path calculation entity (PCE) and the network management. When the path calculation element resides in one endpoint system of an Ethernet path, the PCE on that Ethernet system has to instruct the network management to configure other Ethernet systems, which is not straightforward. Usually it is done the other way around, i.e., the NMS instructs the network nodes.

When the PCE resides in one endpoint system of an Ethernet path, that Ethernet system must implement an SNMP function and the associated procedures to configure CFM at other Ethernet systems. The configuration of such SNMP function introduces additional configuration burden on the Ethernet system. The PCE is not aware of all the nodes along the path if the path descriptor includes ‘loose’ hops, i.e., hops that have not been explicitly defined. If the PCE wants to discover the exact path it must configure all Ethernet systems to process and support trace route packets, i.e., MIPs. In typical network cases the number of systems involved in implementing a path is much less than the number of systems forming the network, as a result many systems in the network are configured unnecessarily. Once the actual path is discovered, then the unused monitoring entities previously deployed at all systems must be removed. Resource reservation protocol—traffic engineering (RSVP-TE) based notification method requires RSVP-TE protocol implementation at every Ethernet system resulting in a significant burden on the control functions of Ethernet systems.

The embodiments of the present invention provide a system and process that overcome these deficiencies. The embodiments provide a system and process where a first entity, that may be a network node or an entity external to the network, which runs link state protocol in order to synchronize its local copy of the Link State Data Base (LSDB) with a set of network nodes together forming a link state domain, and which disseminates a descriptor of an explicit path, instructs several nodes, which are member of the same link state domain, to configure maintenance points in connection with the explicit path in support of validating the establishment of the explicit path and optionally the correct establishment of the path.

In cases where there are bidirectional explicit paths, a second node, which is a member of the same link state domain and is the first endpoint of the explicit path, configures an MEP in connection with the explicit path, validates the establishment of the explicit path making use of the installed maintenance endpoint. This second node validates the correct setup using the installed maintenance endpoint of the explicit path if instructed by the first entity to do so. Finally, the second node disseminates the result of the path validations. A third node, which is member of the same link state domain, receives and processes the result advertised by the second node and determines the outcome of the explicit path setup. The second node can decommission the maintenance points installed in connection with the explicit path after receiving the result of the path validations provided by the second node.

In case of unidirectional explicit paths, a fourth node, which is a member of the same link state domain and is the ingress endpoint of the explicit path, configures an MEP in connection with the explicit path to emit monitoring frames. A fifth node, which is a member of the same link state domain and is egress endpoint of the same explicit path (in further embodiments additional egress points can be attached to the same explicit path to implement point-to-point multi-point connectivity), configures an MEP in connection with the explicit path. The fifth node, after it receives monitoring frames emitted by the fourth node over the explicit path, disseminates the result of the path establishment validation. The fourth node collects the report generated by the fifth node and validates the correct setup of the explicit path if instructed by the first entity to do so. Finally, the fourth node disseminates the result of the path validations. The fourth and fifth nodes can decommission the maintenance points installed in connection with the explicit path after receiving the result of the path validations provided by the fifth node.

In one embodiment of the invention, the nodes are Shortest Path Bridging nodes, they use the IS-IS protocol to advertise the configuration attributes as well as the results, and they use the Ethernet CFM to implement the maintenance points.

The embodiments of the invention provide advantages over the prior art. The embodiments enable network node or an external entity to be aware of the result of the establishment of an explicit path while only making use of link state protocol messages with a decreased amount advertised data. As opposed to chatty link state add-ons, the embodiments minimize the path validation load on the interior gateway protocol (IGP) by selecting a few nodes along the path that actively perform the path setup related validations and generate the reports. Furthermore, the proposed method avoids the complexity of a management based solution.

The Explicit Path Descriptor

The Explicit Path Descriptor (EPD) (e.g. Topology sub-TLV, described in clause 45.1.9 of 802.1Qca D0.7) carries all attributes that are required to provision an explicit path in an Ethernet network. In an example embodiment, the EPD is extended with data structures to instruct Ethernet systems along the explicit path to deploy Maintenance Points (either MEP or MIP) and to provide configuration data for these Ethernet systems to configure the deployed Maintenance Points.

Path Computation Element

According to IEEE 802.1Qca, an entity, referred to as a Path Computation Element (PCE), constructs an Explicit Path Descriptor and disseminates this descriptor using IS-IS. In the embodiments described herein below, during construction of the Explicit Path Descriptor, the PCE includes further information elements into the EPD in order to instruct all endpoint systems (i.e., those Ethernet systems that act as an endpoint of the explicit path) to check the continuity and connectivity of the path. The PCE also includes further information elements into the EPD that provide configuration data for MEPs and MIPs that is required for checking continuity and connectivity of the explicit path defined by the EPD.

The PCE also includes further information elements into the EP Descriptor sub-TLV that instructs the several Ethernet systems to install maintenance points in support of checking whether the installed path is according to the request (i.e., perform a path correctness check). In one embodiment of the present invention, the PCE instructs all Ethernet systems that are listed in the Explicit Path Descriptor except the endpoints to configure a Maintenance Intermediate Point (MIP) and associate these MIPs with the explicit path. In a second embodiment of the present invention, the PCE instructs all Ethernet systems that participate in forming the explicit path except the endpoints to configure an MIP and associate the MIP with the explicit path. In a third embodiment of the present invention, the PCE instructs all Ethernet systems in the network except the endpoints of the explicit path to configure a Maintenance Intermediate Point (MIP) and associate it with the explicit path. In each of the above three embodiments, the PCE instructs the endpoints systems to configure the Maintenance Endpoint (MEP) to support a path correctness check.

In one exemplary implementation that can utilize any of the above embodiments, the continuity of the path is checked using Ethernet CFM Continuity and Connectivity Messages (CCM). In a further exemplary implementation that can utilize any of the above embodiments, the correctness of the path is checked using an Ethernet CFM Linktrace function.

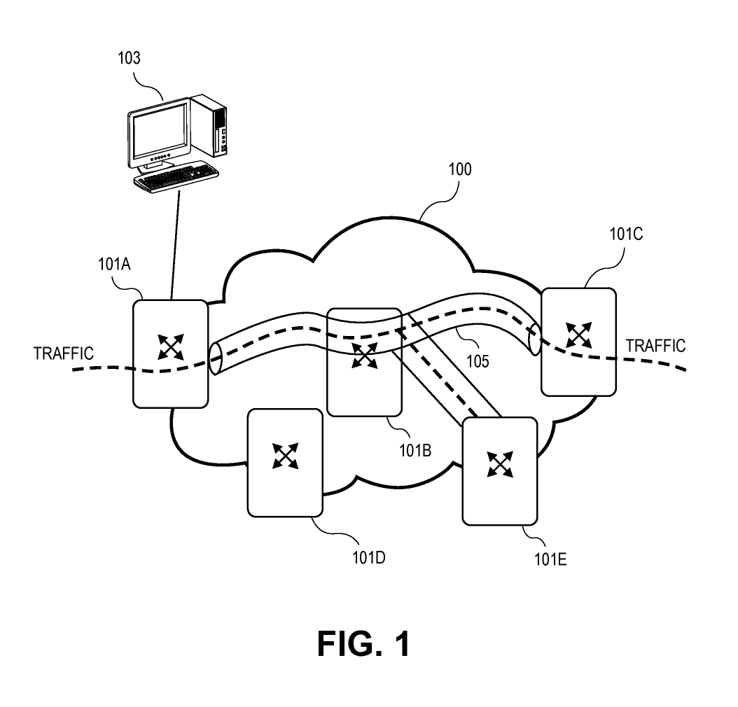

FIG. 1 is an example diagram of one embodiment of an Ethernet network over which an explicit path is provisioned. The illustrated network is simplified for sake of clarity, however one skilled in the art would understand the principles and structures can be applied in larger scale and more complex networking domains.

A network 100 includes a set of network devices 101A-D, which can be Ethernet switches or similar devices as defined further herein below. The network devices 101A-D can be in communication with one another using over any number of combination of links, such as Ethernet links here illustrated as the cloud 100. An explicit path 105 can be defined to traverse this network 100 and the constituent network devices 101A-E such that data traffic assigned to the explicit path will enter the network 100 at a first endpoint handled by network device 101A and will exit the network 100 at a second endpoint handled by network device 101C. The explicit path can traverse any number of intermediate network devices within the network 100. The explicit path can be uni-directional or bi-directional, where traffic traverses the network in one direction or in both directions across the explicit path. In the illustrated example, the explicit path includes an intermediate network device 101B, while other network devices 101D are not included in the explicit path. The explicit path can have branches to additional endpoints such as the endpoint at network device 101E.

The explicit path generation and configuration can be managed by the PCE. The PCE can be implemented by any network device within the network 100 or can be implemented by any computing device in communication with the network devices 101A-E of the network 100. In the illustrated example, the PCE is executed by an external computing device 103, which is in communication with the network devices 101A-E and can generate an EPD that is sent to a network device of network 100 which in turn forwards the EPD to several other network devices, which in turn forward the EPD to additional network devices such that all network devices 101A-E receive the EPD. Each network device examines the EPD and configures the explicit path traffic forwarding and related management. The EPD can be a sub-TLV that is carried within an OSPF link state advertisement (LSA) or in an IS-IS link state PDU (LSP).

Procedures for all Network Devices

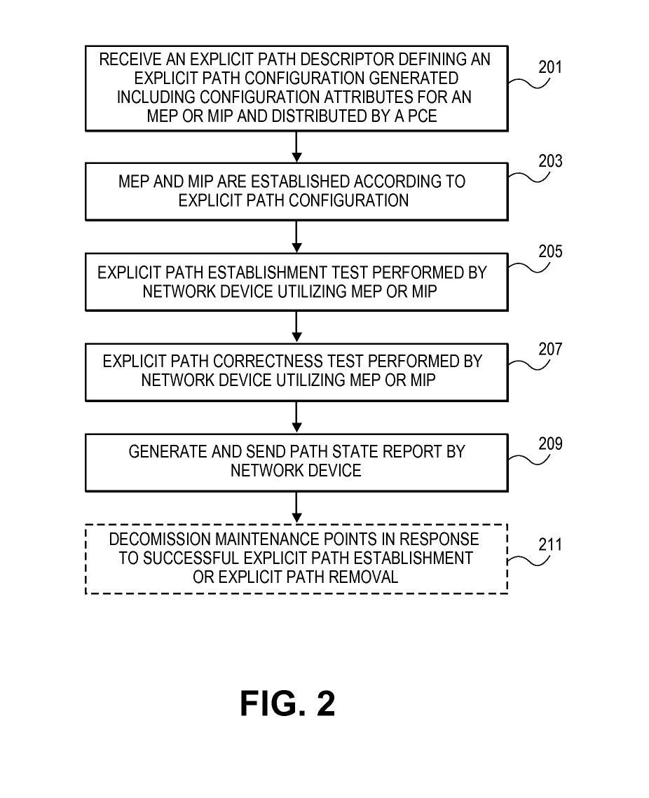

After receiving an EP Descriptor sub-TLV carried by an OSPF Link State Advertisement (LSA) or an IS-IS Link State PDU (LSP), all network devices (e.g., Ethernet systems) in the network execute the procedures dictated by the IEEE 802.1Qca (2013) and in one embodiment of the present invention the network device execute the process illustrated in FIG. 2.

FIG. 2 is a flowchart of one embodiment of a set of processes executed in a network domain to establish an explicit path and to test the explicit path. The process involves the operation of a set of network devices that communicate over a set of links to form a network domain. The process is described from the perspective of one of the set of network devices implementing the processes in conjunction with other devices in the network domain. In one embodiment, the process begins with one of the set of network devices receiving an explicit path descriptor (EPD) defining an explicit path configuration and including MEP and/or MIP configuration attributes where the EPD has been generated and distributed by the PCE (Block 201). The PCE can be executed by any computing device in communication with the network device and the network domain. The PCE can be implemented local to the network device or remote from the network device.

The network device then may establish a maintenance endpoint (MEP) or maintenance intermediate point (MIP) according the EPD and the network device's position within the explicit device (Block 203). The establishment of the MEP or MIP to monitor the explicit path is dependent on whether the network device is an endpoint of the explicit path or is an intermediate point within the explicit path or even not along the explicit path. The network device can be identified in the explicit path, can be outside of the explicit path or can be derived from the set of explicitly identified points in the EPD. If the network device is a part of the explicit path, then its forwarding tables are updated to reflect the necessary forwarding to the next hop of the explicit path. MEPs are deployed only at the endpoints of a path. Depending on the network configuration MIPs can be deployed to any network node except the path endpoints.

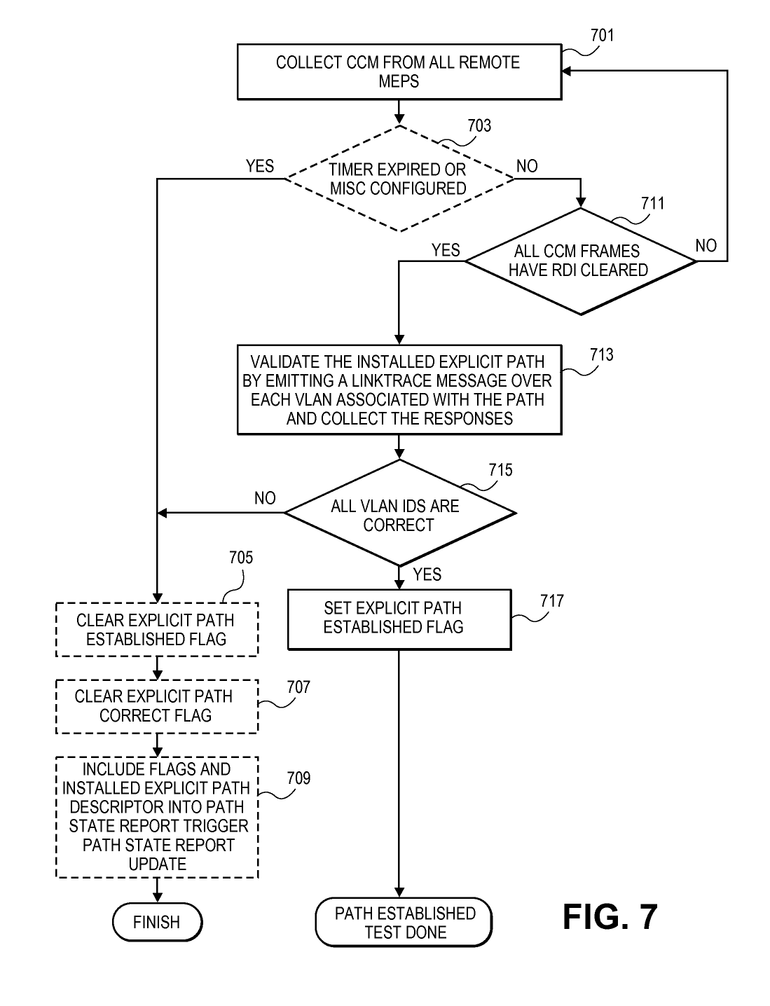

At any point after the establishment of the explicit path, the network device can perform an establishment test to check establishment of the explicit path (Block 205). This process is described herein below in regard to FIG. 7. Similarly, a path correctness test can also be implemented by the network device to check correctness of the explicit path (Block 207). These tests utilize the MEP and/or MIP that have been established in the network according to the EPD. When all tests have been completed, at a regular interval or upon similar circumstances, a path state report can be prepared (Block 209). The network device can generate a path state report based on results of the path establishment and path correctness tests. The path state report including data from the establishment test or the correctness test can be generated and can be sent to the PCE or other computing devices in the network. The path state report is disseminated by IGP, thus, all nodes of the IGP domain receive a copy of the path state report via this dissemination. Therefore, all nodes of the network, including the PCE will receive a copy of the path state report.

In some scenarios, the explicit path is no longer needed and the MEP or MIP points defined to assist with OAM support can be removed from the network domain. Similarly, completion of the path correctness and establishment test can be reported to other network devices in the network domain in the form of a path state report that can be sent along with other relevant information to the PCE or between network devices of the network domain. After the report is sent, successful path testing, explicit path removal or on similar circumstances, the network device can decommission the maintenance points (Block 211).

Depending on the network and explicit path configuration, select subsets of the nodes may perform these functions. In some configurations, only a single endpoint may execute some or all of the functions. One skilled in the art would understand that in a given implementation there can be differing numbers or subsets of the network devices that perform the set of functions described herein above.

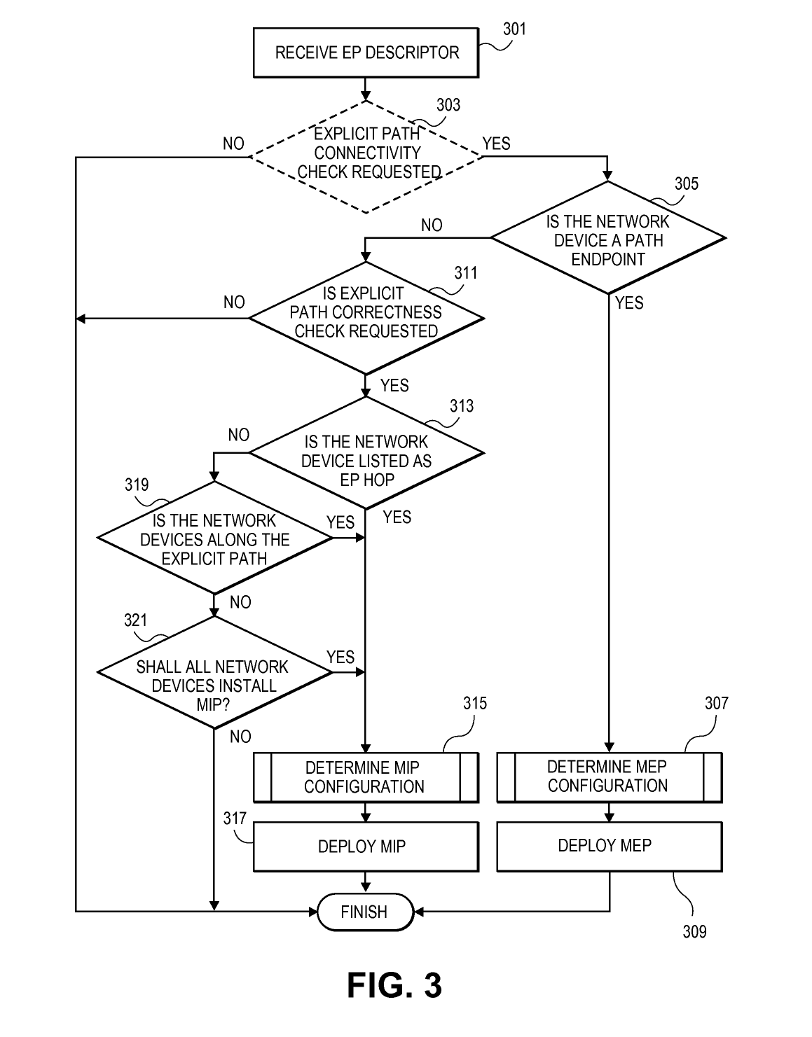

FIG. 3 is a flowchart of one embodiment of the EPD processing and explicit path connectivity check configuration process. The process can be implemented by any network device in the network domain that can receive LSA or LSP from other network devices and from related components including a PCE. Upon receipt of the LSA or LSP including the EPD (Block 301), the network device first checks, if the received EPD indicates that the PCE has requested a connectivity check (Block 303). If not, the process for connectivity check configuration completes. The network device can further process the EPD to establish the configuration for the forwarding of data traffic according the explicit path before, after or in parallel with the connectivity check configuration.

Where a connectivity check is to be performed, then the process checks whether the network device is an endpoint of the explicit path (Block 305). If the network device is an endpoint for the explicit path, then the process determines the MEP configuration (Block 307) and deploys the MEP (Block 309). If more than one virtual local area network (VLAN) identifier (ID) (VID) is listed in the EPD, then all of the listed VIDs are associated to the MEP while the Primary VID (over which the CFM frames except the Linktrace are transmitted according to IEEE 802.1Q-2011) will be the first VID value of the VID list of the EPD.

If the network device is not an endpoint of the explicit path, then the process checks whether the EPD indicates that the PCE has requested a path correctness check (Block 311). If a path correctness check has not been requested, then no more configuration action needs to be done and the connectivity check configuration process finishes.

In the case when the PCE requested a path correctness check, the network device determines whether it needs to deploy and configure an MIP in connection with the explicit path. The process checks whether the network device is listed in the EP Descriptor sub-TLV as a hop, specified by e.g. a Hop sub-TLV (Block 313). If so, the network device configures (Block 315) and deploys an MIP (Block 317). All VIDs listed in the EP Descriptor are bound to the MIP. If the network device is not listed as a hop, then the network device checks if it is along the path (Block 319). To do this test the network device applies the loose hop resolution procedure defined by IEEE 802.1Qca D0.7 (2014). If the network device is along the explicit path, or the PCE requests MIP configuration for all network devices in the network domain (Block 321), then the network device configures (Block 315) and deploys an MIP (Block 317). If none of the checks are positive, then the network device does not need to instantiate an MIP, thus the network device finishes the process.

Encoding CFM Configuration Descriptor

The instructions of the network devices (e.g., Ethernet systems) in the network domain to perform requested operations together with the configuration data are encoded with attributes by the PCE. The required configuration attributes are encoded in several data structures, referred to as sub-TLVs. There are two possible organizations for the instructions and attributes in sub-TLVs.

Interleaved Option

Some monitoring point configuration attributes are path-wide in the sense that they are applicable to all monitoring points associated with the explicit path. This type of attribute is referred to herein as a path-wide attribute. Other attributes are relevant only for one monitoring point instantiated at a network device. This type of attribute is referred to herein as a system-wide attribute.

Path-Wide CFM Attributes Sub-TLV

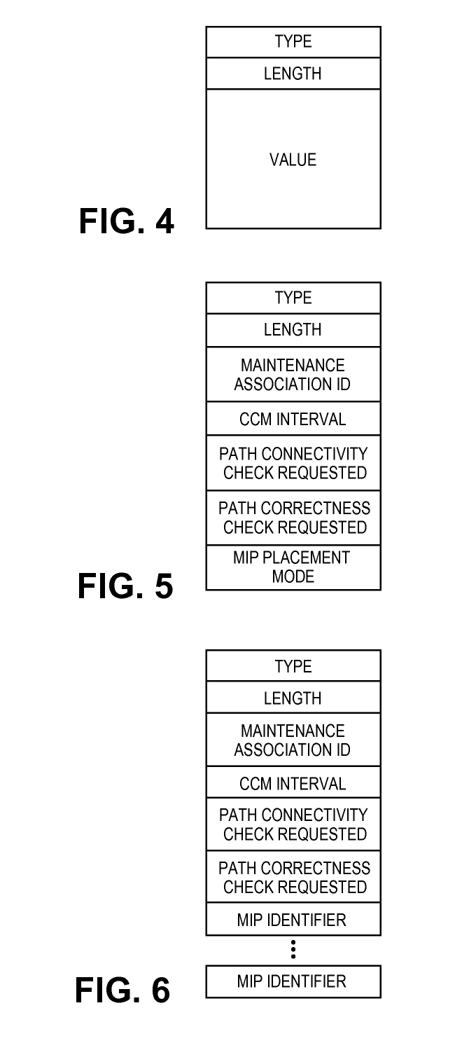

A standard TLV or sub-TLV, which have the same structure, but which are embedded within a value of a TLV is shown in FIG. 4. An example implementation defines a path-wide CFM attributes sub-TLV to encode the path-wide configuration attributes, which is illustrated in FIG. 5, where the sub-TLV encodes a set of attributes including a Maintenance Association (MA) ID (combination of a Maintenance Domain Name and Short MA Name), and a CCM Interval that specifies the interval that the endpoint systems emit CCM Frames. One value of the domain can be reserved to indicate the use of system-wide default configuration. For example it is possible to use the CCM Interval field encoding octet (see for example, Table 21-16 of IEEE 802.1Q (2011)). Value “0” can be used to indicate the use of network wide default.

A further attribute can be a path connectivity check is requested flag. This flag indicates that all endpoint systems shall (1) instantiate and configure an MEP to emit and accept CCM frames and (2) encode the outcome of this check into the state notification.

Another field of the sub-TLV is the path correctness check is requested flag. This flag indicates that endpoint systems shall execute path correctness checking procedures and that some intermediate systems shall deploy and configure an MIP. Furthermore, the sub-TLV may also indicate which intermediate systems shall participate in the path correctness check procedure. This attribute is referred to as “MIP placement mode” and depending on the value the following options can be considered: (1) network devices listed in the EP Descriptor as intermediate systems (i.e., not endpoint system); (2) network devices along the path except the endpoint systems; and (3) network devices of the network domain. This attribute may be derived from the network device local configuration as an alternative.

In one embodiment, the existence of path-wide CFM attributes sub-TLV in the Explicit Path Descriptor sub-TLV implies the instruction of requesting all endpoint system to perform a continuity and connectivity check as well as for several endpoints to disseminate the result of the checks. In such an embodiment, the “path connectivity check is requested” flag is not needed and, therefore, can be omitted from the sub-TLV.

System-Wide CFM Attributes Sub-TLV

The system-wide CFM attributes can be encoded in one sub-TLV, referred to as a system-wide CFM attributes sub-TLV. This sub-TLV can have a general TLV format such as that illustrated in FIG. 4. There are several options for location in which to place this sub-TLV. In one embodiment, the sub-TLV is included in the explicit path sub-TLV, which carries the EPD, after an explicit path hop sub-TLV, which identifies a hop of an explicit path. Then the attributes carried by the sub-TLV are relevant to the hop of the explicit path defined by the last preceding Hop sub-TLV. A second option is to include the sub-TLV into the explicit path hop sub-TLV that identifies the network device that is configured according to the attributes encoded in the sub-TLV. This option necessitates the update of the existing Hop sub-TLV either with a field to carry different sub-TLVs or with data fields encoding the content of the system-wide CFM attributes sub-TLV. The system-wide CFM attributes sub-TLV includes at least one data field, encoded in the value field, specifically a maintenance Endpoint Identifier (2 octets).

Split Option

In this embodiment, all CFM configuration related attributes are placed in a dedicated sub-TLV as illustrated in FIG. 6 that is included into the explicit path sub-TLV. The dedicated sub-TLV can carry a set of attributes including a maintenance association ID (combination of a Maintenance Domain Name and Short MA Name), a CCM Interval configuration attribute, a path correctness check is requested flag, a path connectivity check is requested flag, and an ordered list of maintenance endpoint identifiers. The meaning and the use of the first four attributes are the same as discussed in regard to the interleaved option. An unambiguous order of the endpoint systems is defined based on the order of the Hop sub-TLVs. Then, the order of the MEP identifiers in the list defines which of the endpoints system it refers to. For example, the first MEP ID refers to the first endpoint system, and the last MEP ID refers to the last endpoint system.

In another embodiment, an algorithm can be specified in order to derive the MEP ID from unique IDs belonging to the network device (e.g., media access control (MAC) address, IS-IS System ID, and Port ID or IS-IS Circuit ID) or based on the explicit path advertisement. For example the MEP ID equal to the sequence number of the node in the explicit path list.

In a further embodiment, the existence of this dedicated sub-TLV in the explicit path descriptor sub-TLV implies the instruction of requesting all endpoint systems to perform continuity and connectivity check as well as for several endpoints to disseminate the result of the checks. In this embodiment, the path connectivity check is requested flag is not needed and, therefore, can be omitted from the sub-TLV.

Executing Path Setup and Correctness Checks

Once the monitoring points are instantiated, they start operating according to their configuration. Therefore, in principle any endpoint system is able to conduct the PCE requested path checks and to report the result back to the PCE. As a result of the checks the node determines whether the path is established and whether the established path is correct. In one example embodiment, the results of the path setup and path correctness checks are stored in an explicit path established and explicit path correct fields/flags.

In some embodiments, it is often unnecessary for all endpoint systems to perform the requested path checks. Depending on the type of the installed explicit path, the path setup and correctness check procedures can be optimized. There are several optimization options discussed herein below.

Procedures in Case of Bidirectional Explicit Paths

A bidirectional explicit path means that any endpoints of the explicit path are reachable from any other endpoints of the same explicit path. According to the CFM operation, one of the endpoints can detect if a bidirectional explicit path is up over the first VLAN ID listed in the EPD: the MEP at this endpoint receives CCM frames from MEPs at all other endpoints of the same explicit path and the remote defect indication (RDI) flag is set in none of these CCM frames. The configured explicit path always forms a tree topology (either a co-routed bidirectional point-to-point path or a real tree, i.e. multipoint-to-multipoint path). Therefore, the shape of this tree topology is discovered by one of the endpoints if it emits a Linktrace Message (LTM) and collects the Linktrace Reply (LTR).

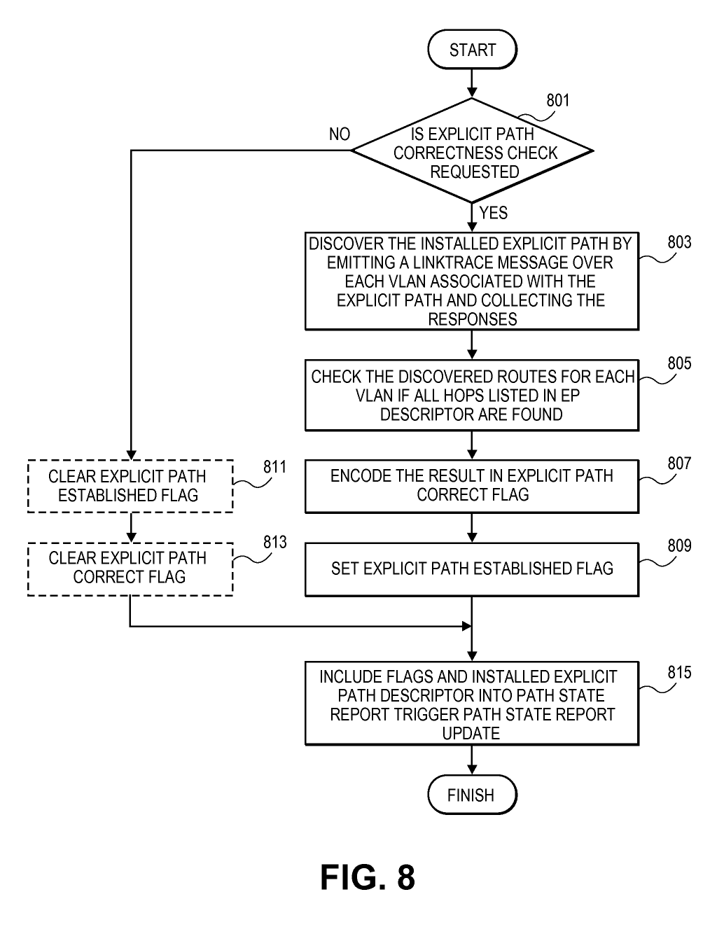

In one embodiment, the system exploits that the first endpoint is able to conduct the requested checks and construct the report to the PCE because of the above CFM operation. This endpoint can implement the procedures illustrated in FIG. 7 and FIG. 8.

FIG. 7 is a flowchart of one embodiment of the path establishment test process performed by a first endpoint of the explicit path. The network device checks whether the explicit path has been established in the data plane and is up and running. In one embodiment, the network device collects the CCM frames through the MEP associated with the explicit path and received from the MEPs associated with the same explicit path by the other endpoints (i.e., remote MEPs) (Block 701).

However, it is also possible that either CCM frames arrive from a non-expected MEP (misconfiguration) or no CCM frames arrive at all for a predefined time period (i.e., a timer expires) (Block 703). In these cases, the path is considered to have failed and the first endpoint clears both explicit path correct (Block 707) and explicit path established flags (Block 705). These flags and the installed path descriptor are then included in the path state report and trigger a path state report update (Block 709).

After collecting the CCMs the first endpoint checks if all received CCM have Remote Defect Indication (RDI) flags cleared (Block 711). If any CCM reported an RDI being set, then the procedure restarts with collecting a second set of CCMs. If all CCMs carried RDI flags that are cleared, then the process checks if all other VLAN IDs associated with the same explicit path have been set. For this purpose, the process transmits a Linktrace Message (LTM) over each VLAN associated with the explicit path and collects the Linktrace Reply (LTR) (Block 713). Then it checks whether replies have been received from all remote endpoints over each VLANs (Block 715). If so, the Ethernet system sets the explicit path established flag (Block 717) with regards to the explicit path and jumps to the correctness check procedure. Otherwise, it clears this flag (Block 705) and the process also clears the explicit path correct flag (Block 707). As a last step the outcome of the procedure is encoded in the path state report, a response is triggered in the form of an updated path state report and the procedure finishes (Block 709).

FIG. 8 is a flowchart of one embodiment a process for path correctness testing executed by a first endpoint of an explicit path. The process checks whether the PCE requested a path correctness check (Block 801). If so, the network device discovers the installed explicit path by emitting a Linktrace Message over each VLAN associated with the path, and collecting the Linktrace Replies (Block 803). The process then matches the installed path discovered by the Linktrace procedure with the requested one specified by the PCE over each VLAN associated with the path. The matching procedure includes a check whether all network devices listed as hops in the EPD sub-TLV are also discovered via the Linktrace procedure (Block 805). The check for correctness can also include determining that the order of the hops matches the order specified in the EPD. After executing the above procedure over each VLAN associated with the explicit path, the process encodes the result in the explicit path correct flag (Block 809). Otherwise, this flag is cleared.

If the PCE did not request path correctness check, the explicit path correct flag is cleared (Block 811) and the explicit path correct flag is cleared (Block 813). A descriptor of the validated explicit path in the EPDB is extended with the explicit path correct flag, the explicit path established flag vector as well as with the discovered path per VLAN.

Finally, regardless of whether a path correctness check has been requested the process completes by triggering generation of the path state report including the explicit path established and explicit path correct flags as part of a path state report update.

In another embodiment, not the entire descriptor is sent back with the flags but the LSP ID of the path descriptor plus the explicit path correct flag, the explicit path established flag vector as well as the discovered path per VLAN.

Procedures in Case of a Unidirectional Point-to-Multipoint Explicit Path

In cases where a unidirectional point-to-multipoint explicit paths or explicit tree is utilized, a root network device that is an endpoint of the explicit path may, for example, only transmit Ethernet frames, while the leaf Ethernet endpoint only receives them. Therefore none of the endpoints will have a full view on the status of the explicit path based only on CCM frames. In one embodiment of the invention, the root endpoint does not configure CCM but it relies only on the Linktrace procedure.

Procedures for Root System

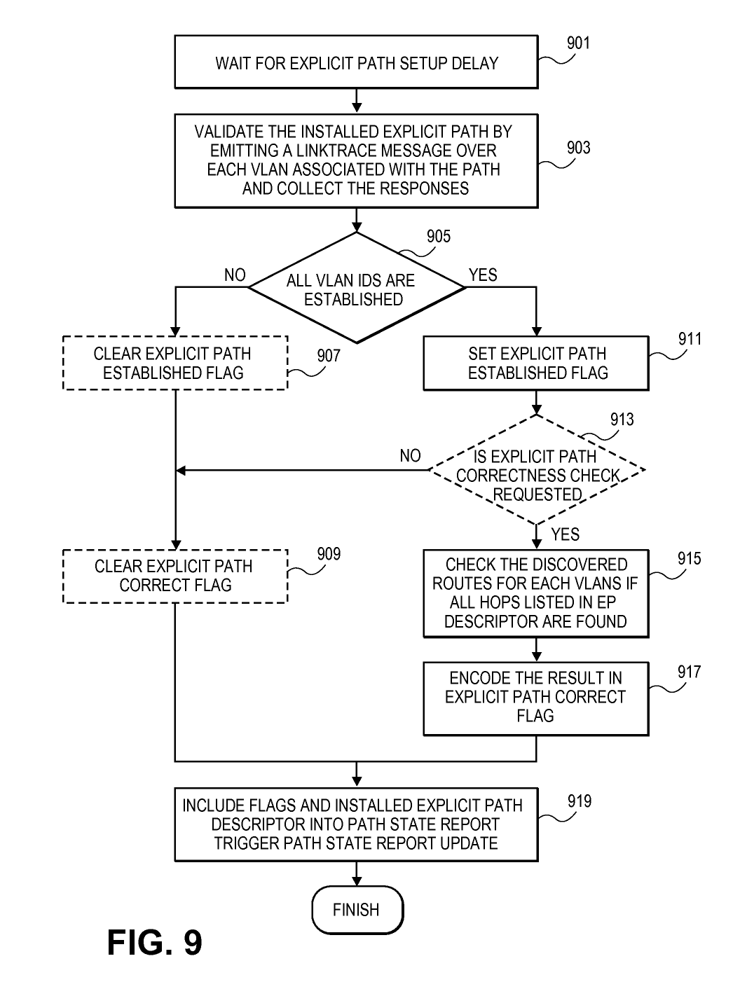

FIG. 9 is a flowchart of one embodiment of a process for performing path correctness by a root system. In one embodiment, the root system (e.g., an Ethernet system) first waits a certain period of time in order to let the other network devices to finish the configuration process (Block 901). The period can have any duration dependent on the technology and the size of the network that provides a sufficient amount of time for properly functioning network devices in the domain to be configured with an explicit path. After the time period expires, the root system checks if all VLAN IDs associated with the explicit path has been set. For this purpose, it emits a Linktrace Message (LTM) over each VLAN and collects the Linktrace Reply (LTR) (Block 903). Then the process checks whether it received replies from all remote endpoints over every VLANs (Block 905). If not, the process clears explicit path established flag (Block 907) and explicit path correct flag (Block 909). As last step the outcome of the process is encoded in a path state report, a response is triggered in the form of a path state report update (Block 919) and the procedure finishes.

If LTRs are received over each VLAN, then the root system sets the explicit path established flag (Block 911) and checks if the path correctness check was requested by the PCE (Block 913). If so, the process matches the installed path discovered by the Linktrace procedure with the requested one specified by the PCE over each VLAN. The matching procedure checks whether all network devices listed as hops in the EPD sub-TLV are also discovered via the Linktrace procedure (Block 915). Checking that all hops of the EPD are discovered can also include checking that they hops are in the same order specified by the EPD. After executing the above procedure over every VLAN, the root system encodes the result in the explicit path correct flag. If this condition is not satisfied, then the explicit path correct flag is cleared (Block 909).

As last step a descriptor of the validated explicit path in the EPDB is extended with the explicit path correct flag, the explicit path established flag vector as well as with the discovered path per path associated VLAN. Finally, the process triggers path state report update (Block 919).

In another embodiment, not the entire descriptor is sent back with the flags as part of the path state report, but the LSP ID of the path descriptor plus the explicit path correct flag, the explicit path established flag as well as the discovered path per path associated VLAN is provided in the path state report.

Path State Report

In any of the options presented herein above, the network device initiates the advertisement of a path state report. There are several example implementations of this path state report making use of link state interior gateway protocols (IGPs). The examples provided utilize the terminology of the IS-IS protocol, however, one skilled in the art would understand that the procedures apply to other link state IGPs, for example to open shortest path first (OSPF), and similar IGPs.

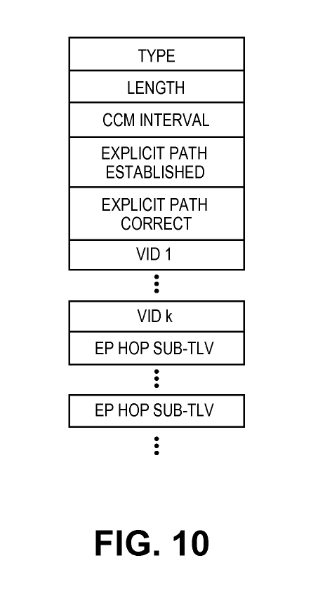

According to IEEE 802.1Qca 2013 each Ethernet system maintains an Explicit Path Database (EPDB) (referred to as an Explicit Tree Database ETDB in later IEEE 802.1Qca drafts such as D0.7) that stores all explicit paths the system is servicing. In one embodiment, the descriptor of an explicit path residing in the EPDB is extended with at least the following information elements as illustrated in FIG. 10: (1) explicit path established flag, which indicates that the explicit path is fully established and is able to transmit Ethernet frames; (2) explicit path correct flag, which indicates that the explicit path is according to the route specified by the explicit path descriptor; and (3) list of Ethernet systems collected during explicit path discovery (e.g., described as a set of Hop sub-TLVs for each VLAN ID associated with the path).

Aggregated Path State LSP Option

In one embodiment, a network device advertises the information elements of all explicit paths that go through that network device in one Link State PDU: the Aggregated Path State LSP. This means that the Aggregated Path State LSP lists the path state reports together with an explicit path identifier of null or more explicit paths. The IGP specific LSP advertisement procedures apply to the Aggregated Path State LSP as well. For example, upon any changes of the content of the LSP, i.e., in the number of path state reports of in the content of any of the path state reports, the network device advertises an updated version of the LSP.

The identifier of the path can be for example a vector of explicit path descriptor attributes or an MD5 hash of the explicit path descriptor or the LSP ID of the LSP carrying the EPD.

Path State LSP Option

In one embodiment, a network device advertises the information elements of each explicit path that goes through that network device in a dedicated Link State PDU that is in the Path State LSP. The IGP specific LSP advertisement procedures apply to the Path State LSP as well. For example, upon any changes of the content of the LSP the network device advertises an updated version of the LSP.

In the case where the explicit path is removed, the corresponding Path Status LSP will not be disseminated any longer. Ceasing periodically advertising such LSPs will result in that other network devices and PCEs to consider that the LSP was removed and its content are then assumed to be no longer valid.

Decommissioning Maintenance Points

The maintenance points are configured together with instantiating an explicit path in order to conduct several tests. These maintenance endpoints may be removed while maintaining the installed explicit paths. The following two subsections discuss two cases when the maintenance endpoints shall be removed and provides two exemplary implementations.

Removing Maintenance Point after Successful Path Setup

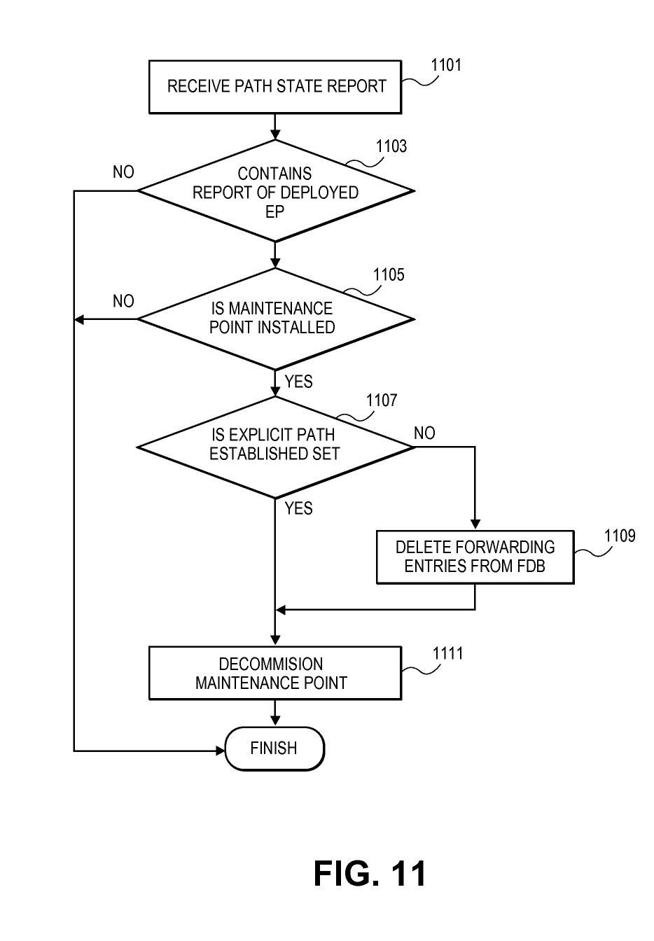

In one embodiment, maintenance points are utilized to perform path correctness and establishment tests after requesting the instantiation of an explicit path. After conducting these tests, these maintenance endpoints may not be used or needed any longer. In one embodiment, all network devices process the Path State Reports originated by other network devices as follows, which is also depicted in FIG. 11.

FIG. 11 is a flowchart of one embodiment of a process for path state processing. The process receives a path state report and begins the analysis of the content of the path state report (Block 1101) and decides whether it describes a report for such an explicit path in which the processing network device is participating (Block 1103). The process checks if a monitoring point (e.g., a MEP or MIP) has been installed in the support of the explicit path (Block 1105). If so, that maintenance point will be decommissioned (Block 1111). In one embodiment, the path state report can be also used to remove the forwarding entries belonging to the explicit path from the FDB if the report indicates the failure of the setup (Block 1109). This can further entail first checking with an explicit path established flag is set for the explicit path (Block 1107). If the flag is cleared then the forwarding entries are cleared (Block 1109). In other cases, the forwarding entries are not removed.

Maintenance Points Together with Removing the Explicit Path

The PCE can request deleting an explicit path via aging out the corresponding LSP. The PCE reaches it by simply ceasing advertising the LSP. According to IEEE802.1Qca the Ethernet system will then remove the FDB entries associated with the explicit path. However, it does not imply decommissioning of the maintenance points belonging to the same explicit path. Therefore, similar to the process described above, the following steps have to be executed (1) check if an MEP was provisioned for that explicit path. If so, decommission the MEP; and (2) check if an MIP was provisioned for that explicit path. If so, decommission the MIP.

Auto-Configuration and Notification Support for Performance Monitoring

As discussed in the previous sub-sections related to maintenance endpoint decommissioning, the maintenance endpoints can be decommissioned after the path establishment and correctness checks have been performed. In further embodiments, these entities may be kept during the lifetime of the explicit path in the support of performance monitoring. The result, performance characteristic information elements of an explicit path can be attached to the Path State LSP or Aggregated Path State LSP. Therefore, the following features are supported: (1) network devices along an explicit path configure their Maintenance Points in support of performance monitoring; (2) several network devices along an explicit configure their Maintenance Endpoints (MEPs) to conduct proactive performance monitoring (where these MEPs periodically generate measurement packets); and (3) several network devices along an explicit path and having MEPs conduct proactive monitoring on the same explicit path, to update Path State LSP or Aggregated Path State LSP with the result of the performance measurement.

Additional Procedures for PCE

To implement this additional feature, the PCE shall instruct the network devices to configure the requested performance monitoring functions. For example it encodes the monitoring functions as a series of flags, where one flag is assigned to one function. The PCE also provides further configuration data for the MEPs and MIPs to setup the requested monitoring function.

The PCE also defines the circumstances when a network device shall originate an updated Path State LSP or Aggregated Path State LSP. For example the PCE may define a threshold or a re-advertisement period. If no such circumstances are defined, the results shall not be reported via IGP.

Additional Procedures for Network Devices

The network devices use these further instructions and configuration data during determining MEP or MIP configuration. The network devices, which received performance monitoring instruction from PCE, will not decommission the MEPs once the path establishment and correctness checks were executed as described herein above. According to some embodiments discussed herein above, the PCE can request several network devices with MEPs along an explicit path, to perform proactive monitoring of that explicit path. The PCE provided additional configuration data is also used to appropriately setup the MEP.

According to the instructions provided by the PCE, the network devices with MEP running proactive monitoring functions along an explicit path read the results of the proactive monitoring functions and when the circumstances defined by the PCE are fulfilled the network devices advertise Path State or Aggregated Path State message carrying the result of the performance monitoring. The result can be for example, the measure value (e.g., delay in millisecond) or the indication that the circumstances were fulfilled (e.g., delay reached the defined threshold).

Configure Protection State Machine

Clause 26.10 of IEEE802.1Q (2011) defines 1:1 path protection for PBB-TE, where the common endpoint systems of two Ethernet paths are able to selectively send Ethernet frames through any of the paths based on connectivity state of the paths reported by the continuity and connectivity verification function. IEEE 802.1Qca is able to create a pair of appropriate Ethernet paths as explicit paths, but it does not provide the any configuration instruction whether and how to build 1:1 path protection from these paths.

One embodiment makes use of the OAM configuration attributes defined for path establishment check together with the instructions of not decommissioning the monitoring points after the path establishment check. According to this embodiment, the paths involved in forming the path protection are advertised in separate Explicit Path sub-TLVs. Each advertised explicit path descriptor is extended with at least following information elements: an unambiguous identifier of the peering explicit path (see ESP and TESI of PBB-TE) and the role of the explicit path described in the descriptor (either working or protection path). If the roles of the explicit paths (which is the working and which is the protection) are not defined the decision which of the path is used by an endpoint is the subject of that endpoint.

There are several attributes, such as timers, like hold-off timer (HoldOfWhile), wait-to-revert timer (WTRWhile), that are relevant to the protection instance and not the Ethernet paths forming it. Therefore, these attributes can be included into the descriptor of one of the explicit paths forming the protection instance. These attributes can be included in both explicit path descriptors; however, same values must be then used at all occurrences of the attribute.

The endpoint systems shall use preconfigured default values for the state machine timers if they are not defined as part of the explicit path descriptors.

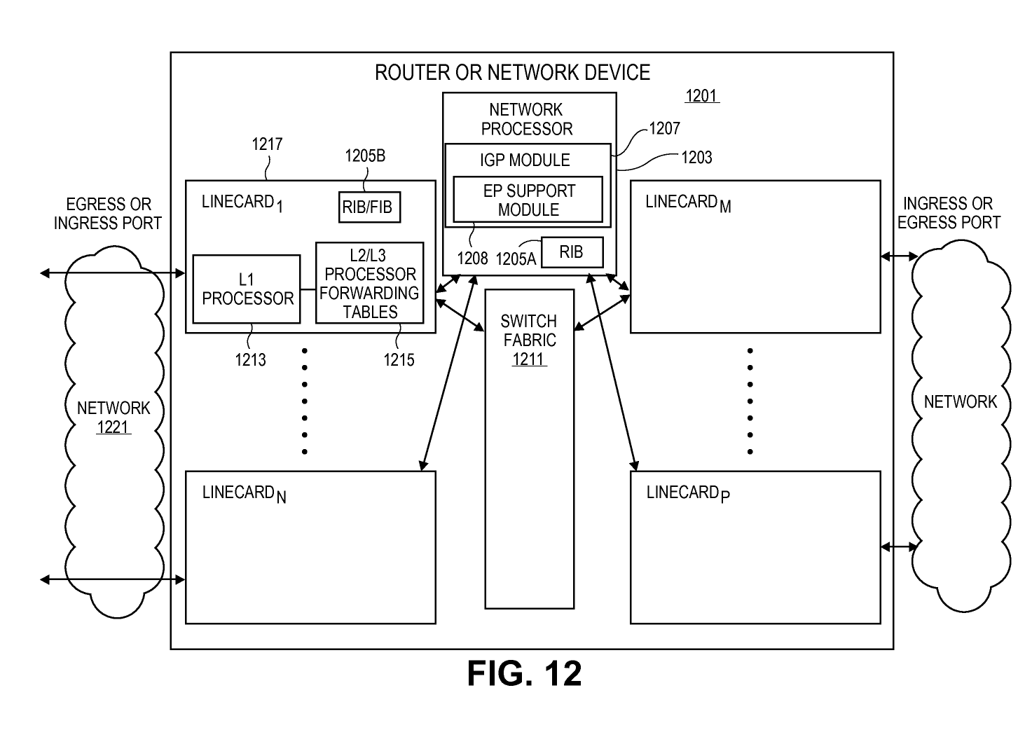

FIG. 12 is a diagram of one embodiment of a network device implementing the OAM aided EP establishment process for IGP in a network domain.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

In one embodiment, the process is implemented by a router 1201 or network device or similar computing device. The router 1201 can have any structure that enables it to receive data traffic and forward it toward its destination. The router 1201 can include a network processor 1203 or set of network processors that execute the functions of the router 1201. A ‘set,’ as used herein, is any positive whole number of items including one item. The router 1201 or network element can execute IGP process functionality via a network processor 1203 or other components of the router 1201. The network processor 1203 can implement the IGP functions stored as an IGP module 1207 and the EP support module 1208, which includes the EP establishment and connectivity testing described herein above. The network processor can also service a routing information base 1205A.

The IGP process functions can be implemented as modules in any combination of software, including firmware, and hardware within the router. The functions of the IGP process that are executed and implemented by the router 1201 include those described further herein above including the EP establishment and connectivity testing.

In one embodiment, the router 1201 can include a set of line cards 1217 that process and forward the incoming data traffic toward the respective destination nodes by identifying the destination and forwarding the data traffic to the appropriate line card 1217 having an egress port that leads to or toward the destination via a next hop. These line cards 1217 can also implement the forwarding information base 1205B, or a relevant subset thereof. The line cards 1217 can also implement or facilitate the IGP process functions described herein above. For example, the line cards 1217 can implement OAM MEP and MIP functions such as Linktrace messaging and CCM messaging and similar functions. The line cards 1217 are in communication with one another via a switch fabric 1211 and communicate with other nodes over attached networks 1221 using Ethernet, fiber optic or similar communication links and media.

The operations of the flow diagrams have been described with reference to the exemplary embodiment of the block diagrams. However, it should be understood that the operations of the flowcharts can be performed by embodiments of the invention other than those discussed, and the embodiments discussed with reference to block diagrams can perform operations different than those discussed with reference to the flowcharts. While the flowcharts show a particular order of operations performed by certain embodiments, it should be understood that such order is exemplary (e.g., alternative embodiments may perform the operations in a different order, combine certain operations, overlap certain operations, etc.).

As described herein, operations performed by the router may refer to specific configurations of hardware such as application specific integrated circuits (ASICs) configured to perform certain operations or having a predetermined functionality, or software instructions stored in memory embodied in a non-transitory computer readable storage medium. Thus, the techniques shown in the figures can be implemented using code and data stored and executed on one or more electronic devices (e.g., an end station, a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable communication media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. One or more parts of an embodiment of the invention may be implemented using different combinations of software, firmware, and/or hardware.

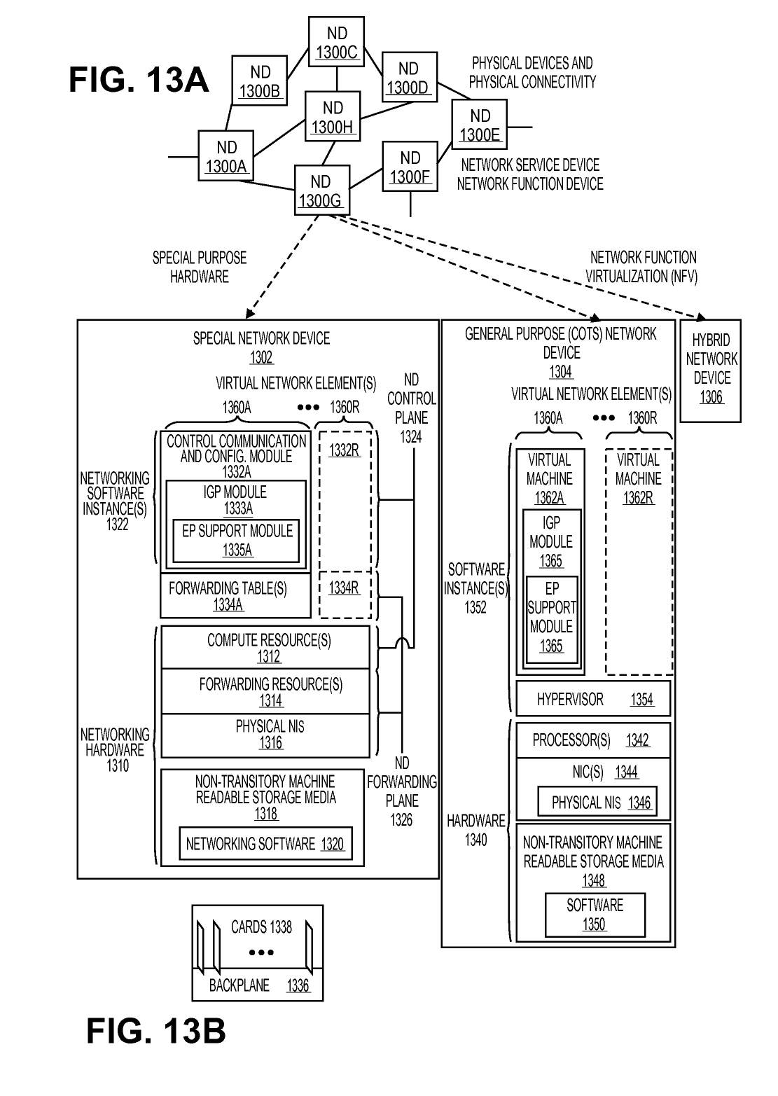

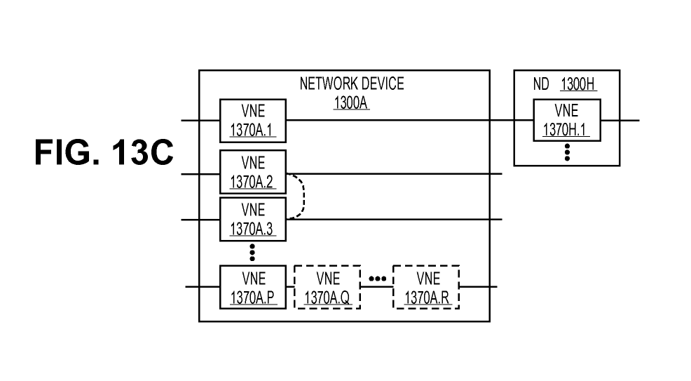

FIG. 13A illustrates connectivity between network devices (NDs) within an exemplary network, as well as three exemplary implementations of the NDs, according to some embodiments of the invention. FIG. 13A shows NDs 1300A-H, and their connectivity by way of lines between A-B, B-C, C-D, D-E, E-F, F-G, and A-G, as well as between H and each of A, C, D, and G. These NDs are physical devices, and the connectivity between these NDs can be wireless or wired (often referred to as a link). An additional line extending from NDs 1300A, E, and F illustrates that these NDs act as ingress and egress points for the network (and thus, these NDs are sometimes referred to as edge NDs; while the other NDs may be called core NDs).

Two of the exemplary ND implementations in FIG. 13A are: 1) a special-purpose network device 1302 that uses custom application—specific integrated—circuits (ASICs) and a proprietary operating system (OS); and 2) a general purpose network device 1304 that uses common off-the-shelf (COTS) processors and a standard OS.

The special-purpose network device 1302 includes networking hardware 1310 comprising compute resource(s) 1312 (which typically include a set of one or more processors), forwarding resource(s) 1314 (which typically include one or more ASICs and/or network processors), and physical network interfaces (NIs) 1316 (sometimes called physical ports), as well as non-transitory machine readable storage media 1318 having stored therein networking software 1320. A physical NI is hardware in a ND through which a network connection (e.g., wirelessly through a wireless network interface controller (WNIC) or through plugging in a cable to a physical port connected to a network interface controller (NIC)) is made, such as those shown by the connectivity between NDs 1300A-H. During operation, the networking software 1320 may be executed by the networking hardware 1310 to instantiate a set of one or more networking software instance(s) 1322. Each of the networking software instance(s) 1322, and that part of the networking hardware 1310 that executes that network software instance (be it hardware dedicated to that networking software instance and/or time slices of hardware temporally shared by that networking software instance with others of the networking software instance(s) 1322), form a separate virtual network element 1330A-R. Each of the virtual network element(s) (VNEs) 1330A-R includes a control communication and configuration module 1332A-R (sometimes referred to as a local control module or control communication module) and forwarding table(s) 1334A-R, such that a given virtual network element (e.g., 1330A) includes the control communication and configuration module (e.g., 1332A), a set of one or more forwarding table(s) (e.g., 1334A), and that portion of the networking hardware 1310 that executes the virtual network element (e.g., 1330A). The IGP module 1333A implements the IGP process including establishing EPs and the EP support module 1335A implements the processes described herein above as part of the Control communication and Configuration Module 1332A or similar aspect of the networking software, which may be loaded and stored in the non-transitory machine readable media 1318A or in a similar location.

The special-purpose network device 1302 is often physically and/or logically considered to include: 1) a ND control plane 1324 (sometimes referred to as a control plane) comprising the compute resource(s) 1312 that execute the control communication and configuration module(s) 1232A-R; and 2) a ND forwarding plane 1326 (sometimes referred to as a forwarding plane, a data plane, or a media plane) comprising the forwarding resource(s) 1314 that utilize the forwarding table(s) 1234A-R and the physical NIs 1316. By way of example, where the ND is a router (or is implementing routing functionality), the ND control plane 1324 (the compute resource(s) 1312 executing the control communication and configuration module(s) 1332A-R) is typically responsible for participating in controlling how data (e.g., packets) is to be routed (e.g., the next hop for the data and the outgoing physical NI for that data) and storing that routing information in the forwarding table(s) 1334A-R, and the ND forwarding plane 1326 is responsible for receiving that data on the physical NIs 1316 and forwarding that data out the appropriate ones of the physical NIs 1316 based on the forwarding table(s) 1334A-R.

FIG. 13B illustrates an exemplary way to implement the special-purpose network device 1302 according to some embodiments of the invention. FIG. 13B shows a special-purpose network device including cards 1338 (typically hot pluggable). While in some embodiments the cards 1338 are of two types (one or more that operate as the ND forwarding plane 1326 (sometimes called line cards), and one or more that operate to implement the ND control plane 1324 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec) (RFC 4301 and 4309), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 1336 (e.g., a first full mesh coupling the line cards and a second full mesh coupling all of the cards).

Returning to FIG. 13A, the general purpose network device 1304 includes hardware 1340 comprising a set of one or more processor(s) 1342 (which are often COTS processors) and network interface controller(s) 1344 (NICs; also known as network interface cards) (which include physical NIs 1346), as well as non-transitory machine readable storage media 1348 having stored therein software 1350. During operation, the processor(s) 1342 execute the software 1350 to instantiate a hypervisor 1354 (sometimes referred to as a virtual machine monitor (VMM)) and one or more virtual machines 1362A-R that are run by the hypervisor 1354, which are collectively referred to as software instance(s) 1352. A virtual machine is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes. Each of the virtual machines 1362A-R, and that part of the hardware 1340 that executes that virtual machine (be it hardware dedicated to that virtual machine and/or time slices of hardware temporally shared by that virtual machine with others of the virtual machine(s) 1362A-R), forms a separate virtual network element(s) 1360A-R. In one embodiment, the virtual machines 1332A-R may execute the described IGP module 1363A and related software described herein above.

The virtual network element(s) 1360A-R perform similar functionality to the virtual network element(s) 1330A-R. For instance, the hypervisor 1354 may present a virtual operating platform that appears like networking hardware 1310 to virtual machine 1362A, and the virtual machine 1362A may be used to implement functionality similar to the control communication and configuration module(s) 1332A and forwarding table(s) 1334A (this virtualization of the hardware 1340 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). However, different embodiments of the invention may implement one or more of the virtual machine(s) 1362A-R differently. For example, while embodiments of the invention are illustrated with each virtual machine 1362A-R corresponding to one VNE 1360A-R, alternative embodiments may implement this correspondence at a finer level granularity (e.g., line card virtual machines virtualize line cards, control card virtual machine virtualize control cards, etc.); it should be understood that the techniques described herein with reference to a correspondence of virtual machines to VNEs also apply to embodiments where such a finer level of granularity is used.

In certain embodiments, the hypervisor 1354 includes a virtual switch that provides similar forwarding services as a physical Ethernet switch. Specifically, this virtual switch forwards traffic between virtual machines and the NIC(s) 1344, as well as optionally between the virtual machines 1362A-R; in addition, this virtual switch may enforce network isolation between the VNEs 1360A-R that by policy are not permitted to communicate with each other (e.g., by honoring virtual local area networks (VLANs)).

The third exemplary ND implementation in FIG. 13A is a hybrid network device 1306, which includes both custom ASICs/proprietary OS and COTS processors/standard OS in a single ND or a single card within an ND. In certain embodiments of such a hybrid network device, a platform VM (i.e., a VM that that implements the functionality of the special-purpose network device 1302) could provide for para-virtualization to the networking hardware present in the hybrid network device 1306.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 1330A-R, VNEs 1360A-R, and those in the hybrid network device 1306) receives data on the physical NIs (e.g., 1316, 1346) and forwards that data out the appropriate ones of the physical NIs (e.g., 1316, 1346). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP) (RFC 768, 2460, 2675, 4113, and 5405), Transmission Control Protocol (TCP) (RFC 793 and 1180), and differentiated services (DSCP) values (RFC 2474, 2475, 2597, 2983, 3086, 3140, 3246, 3247, 3260, 4594, 5865, 3289, 3290, and 3317).

FIG. 13C illustrates various exemplary ways in which VNEs may be coupled according to some embodiments of the invention. FIG. 13C shows VNEs 1370A.1-1370A.P (and optionally VNEs 1380A.Q-1380A.R) implemented in ND 1300A and VNE 1370H.1 in ND 1300H. In FIG. 13C, VNEs 1370A.1-P are separate from each other in the sense that they can receive packets from outside ND 1300A and forward packets outside of ND 1300A; VNE 1370A.1 is coupled with VNE 1370H.1, and thus they communicate packets between their respective NDs; VNE 1370A.2-1370A.3 may optionally forward packets between themselves without forwarding them outside of the ND 1300A; and VNE 1370A.P may optionally be the first in a chain of VNEs that includes VNE 1370A.Q followed by VNE 1370A.R (this is sometimes referred to as dynamic service chaining, where each of the VNEs in the series of VNEs provides a different service—e.g., one or more layer 4-7 network services). While FIG. 13C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 13A, for example, may form part of the Internet or a private network; and other electronic devices (not shown; such as end user devices including workstations, laptops, netbooks, tablets, palm tops, mobile phones, smartphones, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 13A may also host one or more such servers (e.g., in the case of the general purpose network device 1304, one or more of the virtual machines 1362A-R may operate as servers; the same would be true for the hybrid network device 1306; in the case of the special-purpose network device 1302, one or more such servers could also be run on a hypervisor executed by the compute resource(s) 1312); in which case the servers are said to be co-located with the VNEs of that ND.

A virtual network is a logical abstraction of a physical network (such as that in FIG. 6A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN RFC 4364) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network—originated attacks, to avoid malformed route announcements), and management capabilities (e.g., full detection and processing).

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method implemented by a network device to establish an explicit path in a network domain including a plurality of network devices including the network device, where the explicit path defines a path for forwarding traffic across the network domain that is generated by a path computation element (PCE) in communication with the network domain, where operations, administration and management (OAM) is provided to support checking the establishment and correctness of the explicit path based on interior gateway protocols, the method comprising:
receiving an explicit path descriptor (EPD) defining an explicit path configuration including configuration attributes for a maintenance endpoint (MEP) or maintenance intermediate point (MIP) where the EPD is generated and distributed by the PCE;
establishing the MEP or the MIP according to the EPD, the MEP or MIP to monitor the explicit path; and
performing a correctness test to check correctness of the explicit path utilizing the MEP or MIP.

2. The method of claim 1, further comprising:
performing an establishment test to check establishment of the explicit path utilizing the MEP or MIP;
generating a path state report including data from the establishment test or the correctness test; and
sending the path state report to the PCE.

3. The method of claim 1, further comprising:
checking whether an explicit path connectivity request is to be performed;
checking whether the network device is an endpoint where the explicit path connectivity request has been made; and
establishing the MEP where the network device is an endpoint and where the explicit path connectivity request has been made to enable the connectivity check.

4. The method of claim 1, wherein performing the correctness test further comprises:
collecting Continuity and Connectivity Messages (CCM) from all remote maintenance endpoints;
checking whether all CCM have a cleared remote defect indicator (RDI);
validating an installed explicit path by emitting a linktrace message over each virtual local area network (VLAN) associated with the installed explicit path and collecting responses to the linktrace message; and
setting an explicit path established flag in response to determining that all hops for the installed explicit path for a VLAN identifier are found from the responses to the linktrace message.

5. The method of claim 1, wherein performing the correctness test further comprises:
discovering an installed explicit path by emitting a linktrace message over each virtual local area network (VLAN) associated with the installed explicit path and collecting responses to the linktrace messages;
checking discovered routes for each VLAN to find whether all hops listed in the explicit path descriptor are found for the installed explicit path;
encoding results from the discovering in an explicit path correct flag;
setting an explicit path established flag; and
including the explicit path correct flag and the explicit path established flag for the explicit path in a path state report.

6. The method of claim 1, wherein performing the correctness test further comprises:
waiting for a duration of an explicit path setup delay;
validating an installed explicit path by emitting a linktrace message over each virtual local area network (VLAN) associated with the explicit path and collecting responses to the linktrace message;
setting an explicit path established flag in response to all VLAN identifiers being established;
checking whether discovered routes for each VLAN have found all hops listed in an explicit path descriptor;
encoding results in an explicit path correct flag; and
including the explicit path established flag and the explicit path correct flag in a path state report.

7. The method of claim 1, further comprising:
receiving a path state report;
determining whether the path state report includes a report of a deployed explicit path;
determining whether the deployed explicit path includes the MEP or MIP for the network device;
checking whether an explicit path established flag is set;
deleting forwarding entries for the deployed explicit path where the explicit path established flag is not set; and
decommissioning the MEP or MIP for the network device where the deployed explicit path includes the MEP or MIP for the network device.

8. A network device configured to establish an explicit path in a network domain including a plurality of network devices including the network device, where the explicit path defines a path for forwarding traffic across the network domain that is generated by a path computation element (PCE) in communication with the network domain, where operations, administration and management (OAM) support is provided for checking the establishment and correctness of the explicit path based on interior gateway protocols, the network element comprising:
a data store to store a topology of the network domain;
a network processor communicatively coupled to the data store, the network processor to execute an interior gateway protocol (IGP) module including support for OAM, the IGP module configured to receive an explicit path descriptor (EPD) defining an explicit path configuration generated and distributed by the PCE, and to establish a maintenance endpoint (MEP) or maintenance intermediate point (MIP) according to the EPD; and
a line card communicatively coupled to the network processor, the line card to implement the MEP or MIP to monitor the explicit path, and to perform a correctness test to check correctness of the explicit path.

9. The network device of claim 8, wherein the line card is further configured to perform an establishment test to check establishment of the explicit path utilizing the MEP or MIP, and the IGP module is further configured to generate a path state report including data from the establishment test or the correctness test, and to send the path state report to the PCE.

10. The network device of claim 8, wherein the IGP module is further configured to check whether an explicit path connectivity request is to be performed, to check whether the network device is an endpoint where the explicit path connectivity request has been made, and to establish the MEP where the network device is an endpoint and where the explicit path connectivity request has been made to enable the connectivity check.

11. The network device of claim 8, wherein the IGP module is further configured to perform the correctness test by collecting Continuity and Connectivity Messages (CCM) from all remote maintenance endpoints, checking whether all CCM have a cleared remote defect indicator (RDI), validating an installed explicit path by emitting a linktrace message over each virtual local area network (VLAN) associated with the installed explicit path and collecting responses to the linktrace message, and setting an explicit path established flag in response to determining that all hops for the installed explicit path for a VLAN identifier are found from the responses to the linktrace message.

12. The network device of claim 8, wherein the IGP module is further configured to perform the correctness test by discovering an installed explicit path by emitting a linktrace message over each virtual local area network (VLAN) associated with the installed explicit path and collecting responses to the linktrace messages, checking discovered routes for each VLAN to find whether all hops listed in the explicit path descriptor are found for the installed explicit path, encoding results from the discovering in an explicit path correct flag, setting an explicit path established flag, and including the explicit path correct flag and the explicit path established flag for the explicit path in a path state report.

13. The network device of claim 8, wherein the IGP module is further configured to perform the correctness test by waiting for a duration of an explicit path setup delay, validating an installed explicit path by emitting a linktrace message over each virtual local area network (VLAN) associated with the explicit path and collecting responses to the linktrace message, setting an explicit path established flag in response to all VLAN identifiers being established, checking whether discovered routes for each VLAN have found all hops listed in an explicit path descriptor, encoding results in an explicit path correct flag, and including the explicit path established flag and the explicit path correct flag in a path state report.

14. The network device of claim 8, wherein the IGP module is further configured to receive a path state report, to determine whether the path state report includes a report of a deployed explicit path, to determine whether the deployed explicit path includes the MEP or MIP for the network device; to check whether an explicit path established flag is set, to delete forwarding entries for the deployed explicit path where the explicit path established flag is not set, and to decommission the MEP or MIP for the network device where the deployed explicit path includes the MEP or MIP for the network device.

15. A machine-readable medium having stored therein a set of instructions implementing a method, the method operative for a network device to establish an explicit path in a network domain including a plurality of network devices including the network device, where the explicit path defines a path for forwarding traffic across the network domain that is generated by a path computation element (PCE) in communication with the network domain, where operations, administration and management (OAM) is provided to support checking the establishment and correctness of the explicit path based on interior gateway protocols, the set of instruction when executed by a computer processor perform operations comprising:
receiving an explicit path descriptor (EPD) defining an explicit path configuration including configuration attributes for a maintenance endpoint (MEP) or maintenance intermediate point (MIP) where the EPD is generated and distributed by the PCE;
establishing the MEP or the MIP according to the EPD, the MEP or MIP to monitor the explicit path; and
performing a correctness test to check correctness of the explicit path utilizing the MEP or MIP.

16. The machine-readable medium of claim 15, having further instructions stored therein, which when executed cause further operations comprising:
performing an establishment test to check establishment of the explicit path utilizing the MEP or MIP;
generating a path state report including data from the establishment test or the correctness test; and
sending the path state report to the PCE.

17. The machine-readable medium of claim 15, having further instructions stored therein, which when executed cause further operations comprising:
checking whether an explicit path connectivity request is to be performed;
checking whether the network device is an endpoint where the explicit path connectivity request has been made; and
establishing the MEP where the network device is an endpoint and where the explicit path connectivity request has been made to enable the connectivity check.

18. The machine-readable medium of claim 15, having further instructions stored therein, which when executed cause further operations comprising:
collecting Continuity and Connectivity Messages (CCM) from all remote maintenance endpoints;
checking whether all CCM have a cleared remote defect indicator (RDI);
validating an installed explicit path by emitting a linktrace message over each virtual local area network (VLAN) associated with the installed explicit path and collecting responses to the linktrace message; and
setting an explicit path established flag in response to determining that all hops for the installed explicit path for a VLAN identifier are found from the responses to the linktrace message.

19. The machine-readable medium of claim 15, having further instructions stored therein, which when executed cause further operations comprising:
discovering an installed explicit path by emitting a linktrace message over each virtual local area network (VLAN) associated with the installed explicit path and collecting responses to the linktrace messages;
checking discovered routes for each VLAN to find whether all hops listed in the explicit path descriptor are found for the installed explicit path;
encoding results from the discovering in an explicit path correct flag;
setting an explicit path established flag; and
including the explicit path correct flag and the explicit path established flag for the explicit path in a path state report.

20. The machine-readable medium of claim 15, having further instructions stored therein, which when executed cause further operations comprising:
waiting for a duration of an explicit path setup delay;
validating an installed explicit path by emitting a linktrace message over each virtual local area network (VLAN) associated with the explicit path and collecting responses to the linktrace message;
setting an explicit path established flag in response to all VLAN identifiers being established;
checking whether discovered routes for each VLAN have found all hops listed in an explicit path descriptor;
encoding results in an explicit path correct flag; and
including the explicit path established flag and the explicit path correct flag in a path state report.

21. The machine-readable medium of claim 15, having further instructions stored therein, which when executed cause further operations comprising:
receiving a path state report;
determining whether the path state report includes a report of a deployed explicit path;
determining whether the deployed explicit path includes the MEP or MIP for the network device;
checking whether an explicit path established flag is set;
deleting forwarding entries for the deployed explicit path where the explicit path established flag is not set; and
decommissioning the MEP or MIP for the network device where the deployed explicit path includes the MEP or MIP for the network device.
